(19) United States
(12) Patent Application Publication
(10) Pub. No.: US 2022/0090665 A1
(43) Pub. Date: Mar. 24, 2022

(54) TORQUE CONVERTER

(71) Applicant: EXEDY Corporation, Osaka (JP)

(72) Inventor: Kouzo MORI, Osaka (JP)

(73) Assignee: EXEDY Corporation

(21) Appl. No.: 17/408,857

(22) Filed: Aug. 23, 2021

(30) Foreign Application Priority Data
Sep. 23, 2020 (JP) 2020-158334

(51) Int. Cl. F16H 45/02

(52) U.S. Cl. CPC F16H 45/02

(57) ABSTRACT

A torque converter includes a front cover, an impeller, a turbine, and a stator. The impeller forms a fluid chamber together with the front cover. The stator is disposed between an inner peripheral part of the impeller and an inner peripheral part of the turbine. The stator regulates a flow of a fluid flowing from the turbine to the impeller. A flattening ratio is 0.5 or less. The flattening ratio is herein defined as a first ratio of an axial dimension to a radial dimension of a torus formed by the impeller, the turbine, and the stator. A flow area ratio is 0.14 or greater and 0.16 or less. The flow area ratio is herein defined as a second ratio of a minimum flow area of the impeller and the turbine to an area of an imaginary circle having the outer diameter of the torus as the diameter thereof.

### CROSS-REFERENCE TO RELATED APPLICATIONS

This application claims priority to Japanese Patent Application No. 2020-158334 filed Sep. 23, 2020. The entire contents of that application are incorporated by reference herein in their entirety.

### TECHNICAL FIELD

The present invention relates to a torque converter.

### BACKGROUND ART

A torque converter is a device that includes an impeller, a turbine, and a stator and transmits power through a fluid contained in the interior thereof. There has been known a type of torque converter, for which reduction in flattening ratio (i.e., flattening) is made (see e.g., Japan Laid-open Patent Application Publication No. 2005-249206). The term “flattening ratio” herein refers to a ratio of an axial dimension to a radial dimension of a torus (i.e., a space formed by the impeller, the turbine, and the stator). When flattening is made for the torus, the torque converter can be entirely reduced in axial dimension and thereby can be set in an axially limited installation space.

As described above, when flattening is made for the torque converter, the torque converter can be entirely reduced in axial dimension.

However, in attempt to realize compactness in size of the torque converter by flattening or reduction in diameter of the impeller and the turbine, a drawback of reduction in capacity efficient is inevitably posed.

It is an object of the present invention to configure a torque converter such that compactness in entire size thereof can be realized by reducing a flattening ratio, and simultaneously, enhancement in capacity coefficient can be achieved.

### BRIEF SUMMARY

(1) A torque converter according to the present invention includes a front cover, to which a torque is inputted, an impeller, a turbine, and a stator. The impeller forms a fluid chamber together with the front cover. The turbine is opposed to the impeller and outputs the torque. The stator is disposed between an inner peripheral part of the impeller and an inner peripheral part of the turbine. The stator regulates a flow of a fluid flowing from the turbine to the impeller.

Besides, in the present torque converter, a flattening ratio is 0.5 or less. The flattening ratio is herein defined as a ratio (L/H) of an axial dimension (L) to a radial dimension (H) of a torus formed by the impeller, the turbine, and the stator. Furthermore, a flow area ratio is 0.14 or greater and 0.16 or less. The flow area ratio is herein defined as a ratio (a/A) of a minimum flow area (a) of the impeller and the turbine to an area (A) of an imaginary circle having an outer diameter of the torus as a diameter thereof.

Here, the inventor of the present invention found that when the flattening ratio is set to be low, the capacity efficient is enhanced by setting the minimum flow area of the impeller and the turbine to an appropriate value.

Because of this, in the torque converter of the present invention, the flattening ratio is set to be 0.5 or less, and based on this, the flow area ratio, defined as the ratio (a/A) of the minimum flow area (a) of the impeller and the turbine to the area (A) of an imaginary circle having the outer diameter of the torus as the diameter thereof, is set to be 0.14 or greater and 0.16 or less. Accordingly, reduction in flattening ratio, and simultaneously, enhancement in capacity coefficient can be achieved.

(2) Preferably, the flow area ratio (a/A) is 0.15 or greater and 0.16 or less.

(3) Preferably, the flattening ratio (L/H) is 0.2 or greater.

Overall, according to the present invention described above, enhancement in capacity coefficient can be achieved in a torque converter that compactness in size thereof is made by flattening.

### BRIEF DESCRIPTION OF THE DRAWINGS

FIG. 1 is a partial cross-sectional view of a torque converter according to a preferred embodiment of the present invention.

FIG. 2 is a characteristic diagram showing a relation between a flow area ratio of the torque converter and an UP (increase) ratio in capacity coefficient.

FIG. 3 is a schematic diagram of a torus for explaining the UP (increase) ratio in capacity coefficient.

### DETAILED DESCRIPTION

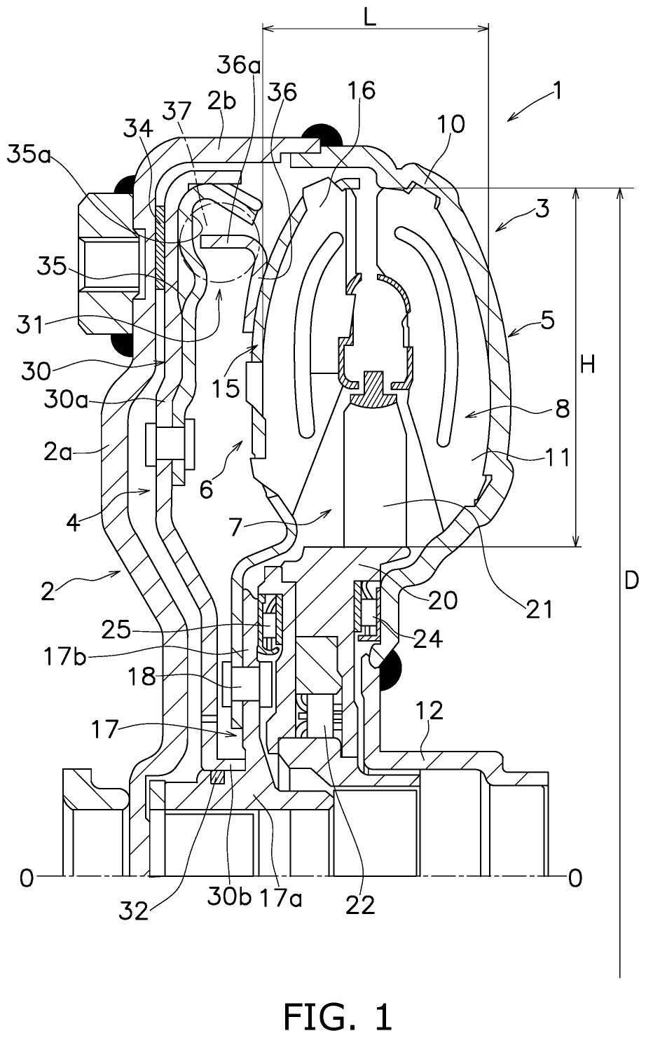

FIG. 1 is a schematic vertical cross-sectional view of a torque converter 1 employing a preferred embodiment of the present invention. The torque converter 1 is a device for transmitting a torque from a crankshaft of an engine (not shown in the drawings) to an input shaft of a transmission (not shown in the drawings). In FIG. 1, the engine (not shown in the drawing) is disposed on the left side, whereas the transmission (not shown in the drawing) is disposed on the right side. Line 0-0 depicted in FIG. 1 is a rotational axis of the torque converter 1.

It should be noted that in the following explanation, the term “axial direction” refers to an extending direction of the rotational axis of a torque converter 1. On the other hand, the term “circumferential direction” refers to a circumferential direction of an imaginary circle about the rotational axis, whereas the term “radial direction” refers to a radial direction of the imaginary circle about the rotational axis. It should be noted that the circumferential direction is not required to be perfectly matched with that of the imaginary circle about the rotational axis. Likewise, the radial direction is not required to be perfectly matched with a diameter direction of the imaginary circle about the rotational axis.

### [Entire Configuration]

The torque converter 1 includes a front cover 2, a torque converter body 3, and a lock-up device 4.

The front cover 2 is fixed to an input-side member. The front cover 2 includes a disc portion 2a and a tubular portion 2b. The tubular portion 2b is shaped to extend axially toward the transmission from an outer peripheral part of the disc portion 2a.

The torque converter body 3 includes an impeller 5, a turbine 6, and a stator 7. Besides, an annular space (torus) 8 is formed by the impeller 5, the turbine 6, and the stator 7.

The impeller 5 includes an impeller shell 10, a plurality of impeller blades 11 fixed to the inside of the impeller shell 10, and an impeller hub 12 fixed to an inner peripheral part of the impeller shell 10. Besides, the impeller shell 10 is fixed at an outer peripheral part thereof to the tubular portion 2b of the front cover 2 by welding. As a result, a fluid chamber, the interior of which is filled with hydraulic oil (fluid), is formed by the front cover 2 and the impeller shell 10.

The turbine 6 is opposed to the impeller 5. The turbine 6 includes a turbine shell 15, a plurality of turbine blades 16 fixed to the inside of the turbine shell 15, and a turbine hub 17. The turbine hub 17 includes a hub 17a and a flange 17b. The hub 17a is made in shape of a tube extending in the axial direction. The flange 17b extends radially outward from the hub 17a. The turbine shell 15 is fixed at an inner peripheral part thereof to the flange 17b by a plurality of rivets 18. Besides, the hub 17a is provided with a spline hole in an inner peripheral part thereof such that the input shaft of the transmission (not shown in the drawings) is engaged therewith.

The stator 7 is disposed between an inner peripheral part of the impeller 5 and that of the turbine 6. The stator 7 is a mechanism for regulating the flow of the hydraulic oil returning from the turbine 6 to the impeller 5. The stator 7 includes a carrier 20 having an annular shape and a plurality of stator blades 21 provided on the outer peripheral surface of the carrier 20. The carrier 20 is supported by a stationary shaft (not shown in the drawings) through a one-way clutch 22.

A thrust bearing 24 is disposed between the impeller hub 12 and the carrier 20, whereas a thrust bearing 25 is disposed between the carrier 20 and the turbine hub 17.

### [Relations in Dimension Among Respective Parts of Torque Converter]

The present torque converter 1 is reduced in axial dimension. Specifically, a flattening ratio (L/H) is defined as a ratio of an axial dimension (L) to a radial dimension (H) of the torus 8 and is set to be 0.5 in the present preferred embodiment.

It should be noted that the radial dimension (H) of the torus 8 is defined as a distance between the outer peripheral surface of the carrier 20 and a radially outermost part on the inner peripheral surface of either the impeller shell 10 or the turbine shell 15. On the other hand, the axial dimension (L) is defined as a distance, at which the inner peripheral surface of the impeller shell 10 and that of the turbine shell 15 are separated farthest from each other.

Besides, a flow area ratio (a/A) is defined as a ratio of the minimum flow area (a) of the impeller 5 and the turbine 6 to the area (A) of an imaginary circle having the outer diameter (D) of the torus 8 as the diameter thereof and is set to be 0.15 in the present preferred embodiment. It should be noted that the flow area ratio is preferably 0.14 or greater and 0.16 or less and is more preferably 0.15 or greater and 0.16 or less.

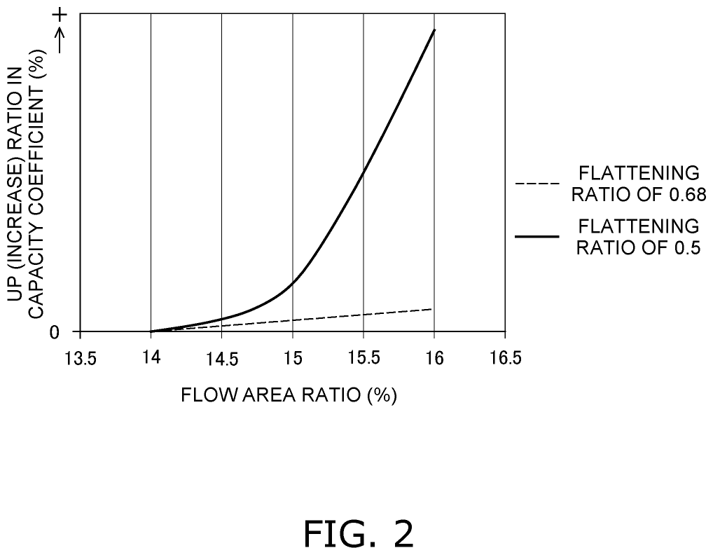

By thus setting the dimensions of the respective parts, enhancement in capacity coefficient can be achieved. Specifically, FIG. 2 shows comparison between a characteristic obtained at a flattening ratio of 0.5 and that obtained at a flattening ratio of 0.68. When the flow area ratio is set to be 14% (0.14) or greater, enhancement in capacity coefficient can be better achieved at a flattening ratio of 0.5. Besides, when the flow area ratio is set to be 15% (0.15) or greater at a flattening ratio of 0.5, enhancement in capacity coefficient is made remarkable.

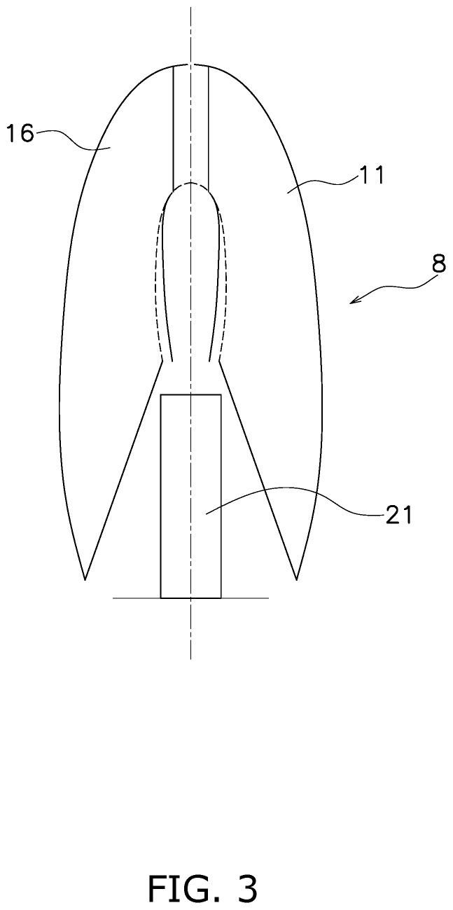

In FIG. 2, the vertical axis shows an UP (increase) ratio in capacity coefficient. Now, the term “UP (increase) ratio in capacity coefficient” will be explained with an example of a torus with a flattening ratio of 0.5. As shown in FIG. 3, when a core part of the torus is improved in flow area ratio from 14% (depicted with dotted line) to 16% (depicted with solid line), the term “UP (increase) ratio in capacity coefficient” refers to a ratio of a capacity coefficient obtained after improvement to that obtained before improvement.

UP (increase) ratio in capacity coefficient=[(Capacity coefficient after improvement)/(Capacity coefficient before improvement)]×100

Capacity coefficient=(Input torque)/(Input rotational speed)²

In other words, FIG. 2 shows that the capacity coefficient increases in both settings of flattening ratio (0.5 and 0.68) by setting the flow area ratio to be 14% or greater.

It should be noted that the respective characteristics in FIG. 2 are analytical results obtained with heretofore known finite volume method and show values of UP (increase) ratio in capacity coefficient, where the flow area ratio is changed from 14% to 16% at the respective settings of flattening ratio.

It was herein found that when the flattening ratio exceeds 0.5, as shown at a flattening ratio of 0.68, enhancement in capacity coefficient cannot be expected even by variously changing the flow area ratio. Therefore, preferably, the flattening ratio is 0.5 or less and is simultaneously 0.2 or greater. When the flattening ratio is less than 0.2 or when the flow area ratio is less than 14% (0.14), the flow area of the impeller and the turbine is made much smaller, whereby a torque converter configured as herein described cannot satisfactorily function.

On the other hand, it is difficult to create a torque converter configured such that the flow area ratio exceeds 16% (0.16), while the flattening ratio is set to be 0.5 or less.

Based on the above, for achieving enhancement in capacity coefficient, the flattening ratio (L/H) is preferably set to be 0.2 or greater and 0.5 or less, while the flow area ratio (a/A) is preferably set to be 0.14 or greater and 0.16 or less and is more preferably set to be 0.15 or greater and 0.16 or less. It should be noted that the UP (increase) ratio in capacity coefficient changes when the flow area ratio becomes 0.15 or greater. As a factor of this change, it can be assumed that the blades in the impeller and/or so forth are changed in shape with change in flow area ratio.

### [Lock-up Device 4]

The lock-up device 4 includes a piston 30 and a damper mechanism 31.

The piston 30 includes a body 30a having a disc shape and an inner tubular portion 30b. The body 30a is opposed to the front cover 2. The inner tubular portion 30b is formed by axially extending the inner peripheral end of the body 30a toward the transmission. The inner tubular portion 30b is supported by the outer peripheral surface of the hub 17a of the turbine hub 17, while being axially movable and rotatable relative to the hub 17a. A seal member 32 is disposed on the outer peripheral surface of the hub 17a.

Furthermore, a friction facing 34, having an annular shape, is fixed to an outer peripheral part of the piston 30. The friction facing 34 is opposed to a friction surface provided on an outer peripheral part of the front cover 2 and is capable of being pressed onto the friction surface.

The damper mechanism 31 includes a retaining plate 35, a driven plate 36, and a plurality of torsion springs 37.

The retaining plate 35 is coupled at an inner peripheral part thereof to the piston 30 by at least one rivet. Besides, the retaining plate 35 is provided with an accommodation portion 35a for accommodating and supporting the torsion springs 37 in an outer peripheral part thereof. The plural torsion springs 37 are accommodated in the accommodation portion 35a.

The driven plate 36 is an annular plate fixed to the outer peripheral side of the turbine shell 15. The driven plate 36 includes a plurality of engaging pawls 36a. The plural engaging pawls 36a extend toward the front cover 2 and are engaged with both circumferential ends of the torsion springs 37.

### [Action]

The action of the torque converter 1 is similar to that of a heretofore known torque converter, and hence, will be hereinafter briefly explained.

When a torque is transmitted from the crankshaft of the engine (not shown in the drawings) to the front cover 2 and the impeller 5, the torque is transmitted from the impeller 5 to the turbine 6 through the hydraulic oil contained in the torus 8. The torque transmitted to the turbine 6 is outputted to the input shaft (not shown in the drawings) through the turbine hub 17. The hydraulic oil, flowing from the turbine 6 to the impeller 5, is regulated in flow by the stator 7 and flows toward the impeller 5.

When the hydraulic oil, contained in a space between the front cover 2 and the piston 30, is drained from the inner peripheral side, the piston 30 is moved toward the front cover 2 by difference in hydraulic pressure, whereby the friction facing 34 is pressed onto the friction surface of the front cover 2. As a result, the torque is directly transmitted from the front cover 2 to the turbine hub 17 through the lock-up device 4.

### OTHER PREFERRED EMBODIMENTS

The present invention is not limited to the preferred embodiment described above, and a variety of changes or modifications can be made without departing from the scope of the present invention.

The configuration of the lock-up device is not limited to that in the preferred embodiment described above and can be made in form of a multi-plate clutch.

### REFERENCE SIGNS LIST

1 Torque converter
2 Front cover
5 Impeller
6 Turbine
7 Stator
8 Torus

What is claimed is:

1. A torque converter comprising:
a front cover to which a torque is inputted;
an impeller forming a fluid chamber together with the front cover;
a turbine opposed to the impeller, the turbine configured to output the torque; and
a stator disposed between an inner peripheral part of the impeller and an inner peripheral part of the turbine, the stator configured to regulate a flow of a fluid flowing from the turbine to the impeller, wherein
a flattening ratio is 0.5 or less, the flattening ratio defined as a first ratio of an axial dimension to a radial dimension of a torus formed by the impeller, the turbine, and the stator, and
a flow area ratio is 0.14 or greater and 0.16 or less, the flow area ratio defined as a second ratio of a minimum flow area of the impeller and the turbine to an area of an imaginary circle having an outer diameter of the torus as a diameter thereof.

2. The torque converter according to claim 1, wherein the flow area ratio is 0.15 or greater and 0.16 or less.

3. The torque converter according to claim 1, wherein the flattening ratio is 0.2 or greater.
